(19) United States
(12) Patent Application Publication
(10) Pub. No.: US 2025/0031138 A1
(43) Pub. Date: Jan. 23, 2025

(54) APPARATUS AND METHOD FOR MANAGING SESSION IN WIRELESS COMMUNICATION SYSTEM

(71) Applicant: Samsung Electronics Co., Ltd., Suwon-si (KR)

(72) Inventors: Hoyeon LEE, Suwon-si (KR); Dongeun SUH, Suwon-si (KR)

(21) Appl. No.: 18/774,048

(22) Filed: Jul. 16, 2024

(30) Foreign Application Priority Data
Jul. 20, 2023 (KR) 10-2023-0094652
Aug. 10, 2023 (KR) 10-2023-0105132

(51) Int. Cl. H04W 48/18; H04W 68/00; H04W 76/10

(52) U.S. Cl. CPC H04W 48/18; H04W 68/00; H04W 76/10

(57) ABSTRACT

The present disclosure relates to a 5G communication system or a 6G communication system for supporting higher data rates beyond a 4G communication system such as long term evolution (LTE). According to an embodiment, a method performed by a UE is provided. The method comprises transmitting, to an access and mobility management function (AMF), information indicating that the UE supports network slice replacement feature, and in case that there is a protocol data unit (PDU) session associated with a single network slice selection assistance information (S-NSSAI) that needs to be replaced, receiving, from the AMF, a mapping of the S-NSSAI to an alternative S-NSSAI.

### CROSS-REFERENCE TO RELATED APPLICATION(S)

This application is based on and claims priority under 35 U.S.C. § 119 (a) of a Korean patent application number 10-2023-0094652, filed on Jul. 20, 2023, in the Korean Intellectual Property Office, and of a Korean patent application number 10-2023-0105132, filed on Aug. 10, 2023, in the Korean Intellectual Property Office, the disclosure of each of which is incorporated by reference herein in its entirety.

### BACKGROUND

### 1. Field

The disclosure relates to an apparatus and method for managing a session in a wireless communication system.

### 2. Description of the Related Art

5^{th} generation (5G) mobile communication technologies define a wide frequency band for enabling a fast data rate and a new service, and can be implemented not only in a frequency band of a ‘Sub 6 GHz’ band, such as 3.5 GHz or the like but also implemented in an ultra-high frequency band (millimeter wave (mmWave)) of an ‘Above 6 GHz’ band, such as 28 GHz, 39 GHz, or the like. In addition, in a case of 6^{th} generation (6G) mobile communication technologies that is referred to as Beyond-5G system, in order to achieve a data rate that is 50 times as fast as 5G mobile communication technologies and 1/10 the radio latency thereof, it has been considered to implement 6G mobile communication technologies in a terahertz band (for example, 95 GHz to 3 THz bands).

In the early stage of the development of 5G mobile communication technologies, in order to support services and fulfill performance requirements in association with enhanced mobile broadband (eMBB), ultra reliable low latency communications (URLLC), and massive machine-type communications (mMTC), there has been ongoing standardization regarding beamforming and massive multiple input multiple output (MIMO) for decreasing path loss of radio waves and increasing transmission distances of radio waves in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions about improvement and performance enhancement of initial 5G mobile communication technologies in view of services to be supported by 5G mobile communication technologies, and there has been physical layer standardization about technologies, such as vehicle-to-everything (V2X) for aiding driving determination by autonomous vehicles based on information about positions and states of vehicles transmitted by the vehicles and for enhancing user convenience, new radio unlicensed (NR-U) aimed at system operations conforming to various regulation-associated requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services via interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

When such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), or the like, 5G performance improvement and complexity reduction by utilizing artificial intelligence (AI) and machine learning (ML), AI service support, metaverse service support, drone communication, or the like.

In addition, such development of 5G mobile communication systems will serve as a base for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus in a wireless communication system.

According to an embodiment of the disclosure, a method performed by a user equipment (UE) in a wireless communication system is provided. The method may comprise transmitting, to an access and mobility management function (AMF), information indicating that the UE supports network slice replacement feature. The method may comprise, in case that there is a protocol data unit (PDU) session associated with a single network slice selection assistance information (S-NSSAI) that needs to be replaced, receiving, from the AMF, a mapping of the S-NSSAI to an alternative S-NSSAI. In case that the S-NSSAI is replaced by the alternative S-NSSAI, the PDU session is associated with both of the S-NSSAI and the alternative S-NSSAI.

According to an embodiment of the disclosure, a user equipment (UE) in a wireless communication system is provided. The UE may comprise a transceiver; and at least one processor. The at least one processor may be configured to transmit, to an access and mobility management function (AMF), information indicating that the UE supports network slice replacement feature. The at least one processor may be configured to receive, from the AMF, a mapping of the S-NSSAI to an alternative S-NSSAI, in case that there is a protocol data unit (PDU) session associated with a single network slice selection assistance information (S-NSSAI) that needs to be replaced. In case that the S-NSSAI is replaced by the alternative S-NSSAI, the PDU session is associated with both of the S-NSSAI and the alternative S-NSSAI.

According to an embodiment of the disclosure, a method performed by an access and mobility management function (AMF) in a wireless communication system is provided. The method may comprise receiving, from a user equipment (UE), information indicating that the UE supports network slice replacement feature. The method may comprise, in case that single network slice selection assistance information (S-NSSAI) becomes unavailable or congested, determining that the S-NSSAI is to be replaced with an alternative S-NSSAI. In case that there is a protocol data unit (PDU) session associated with the S-NSSAI that needs to be replaced, transmitting, to the UE, a mapping of the S-NSSAI to the alternative S-NSSAI, the mapping of the S-NSSAI to the alternative S-NSSAI is stored in UE context in the AMF.

According to an embodiment of the disclosure, an access and mobility management function (AMF) in a wireless communication system is provided. The AMF may comprise a transceiver; and at least one processor. The at least one processor may be configured to receive, from a user equipment (UE), information indicating that the UE supports network slice replacement feature. The at least one processor may be configured to determine that the S-NSSAI is to be replaced with an alternative S-NSSAI in case that single network slice selection assistance information (S-NSSAI) becomes unavailable or congested. The at least one processor may be configured to transmit, to the UE, a mapping of the S-NSSAI to the alternative S-NSSAI, wherein the mapping of the S-NSSAI to the alternative S-NSSAI is stored in UE context in the AMF, in case that there is a protocol data unit (PDU) session associated with the S-NSSAI that needs to be replaced.

Additional aspects will be set forth in part in the description which follows and, in part, will be apparent from the description, or may be learned by practice of the presented embodiments of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a configuration of a single-network slice selection assistance information information element (S-NSSAI IE) according to an embodiment of the disclosure;

FIG. 2 illustrates architecture of a mobile communication system according to an embodiment of the disclosure;

FIG. 3 illustrates a procedure in which an access and mobility management function (AMF) transmits user equipment (UE) policy information to a UE in a wireless communication system, according to an embodiment of the disclosure;

FIG. 4 illustrates a procedure of determining and managing alternative slice information in a registration procedure in a wireless communication system, according to an embodiment of the disclosure;

FIG. 5 illustrates a new protocol data unit (PDU) session establishment procedure in a wireless communication system, according to an embodiment of the disclosure;

FIG. 6 illustrates a procedure for using an existing PDU session in a wireless communication system, according to an embodiment of the disclosure;

FIG. 7 is a diagram illustrating a configuration of a network entity according to an embodiment of the disclosure; and

FIG. 8 is a diagram illustrating a configuration of a UE (also referred to as the terminal) according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Hereinafter, the disclosure relates to an apparatus and method for providing a network slice in a wireless communication system. More particularly, the disclosure describes a technology by which a mobile communication network that provides a network slice function can control and manage user equipment (UE) configuration information in a wireless communication system.

In the 3^{rd} generation partnership project (3GPP) standard, 5^{th}-generation (5G) network system architecture and procedure are standardized. A mobile communication operator may provide various services in the 5G network. In order to provide each service, the mobile communication operator needs to satisfy different service requirements (e.g., a delay time, a communication range, a data rate, a bandwidth, reliability, or the like) for each service. To this end, the mobile communication operator may configure network slices, and may allocate a network resource appropriate for a particular service for each network slice or each set of network slices. The network resource may indicate a network function (NF) or a logic resource provided by an NF or radio resource allocation of a base station (BS), or the like.

For example, the mobile communication operator may configure network slice A for providing a mobile broadband service, may configure network slice B for providing a vehicle communication service, and may configure network slice C for providing an Internet of things (IoT) service. For example, in the 5G network, a service may be provided on a network slice specialized for a feature of each service. As a differentiator for distinguishing between network slices, single-network slice selection assistance information (S-NSSAI) defined in the 3GPP may be used.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

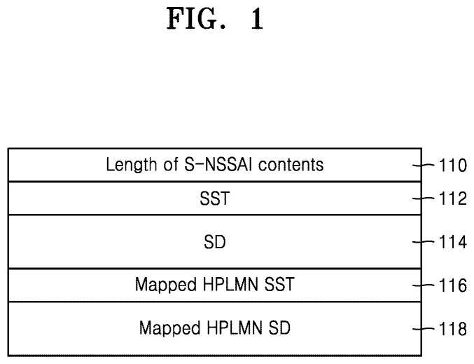

FIG. 1 is a diagram illustrating a configuration of an S-NSSAI information element (IE) according to an embodiment of the disclosure.

Referring to FIG. 1, one S-NSSAI may include at least one of a home public land mobile network (home PLMN: HPLMN) slice/service type (SST) 116 used by a HPLMN, a HPLMN slice differentiator (SD) 118 used by a HPLMN, an SST 112 used by a serving PLMN, a SD 114 used by a serving PLMN, or a length of S-NSSAI contents 110.

In a non-roaming situation, the SST 112 used by the serving PLMN may be the HPLMN SST 116 used by the HPLMN, and in addition, the SD 114 used by the serving PLMN may be the HPLMN SD 118 used by the HPLMN.

In a roaming situation, the SST 112 used by the serving PLMN may be an SST used by a visited PLMN (VPLMN), and in addition, the SD 114 used by the serving PLMN may be may be an SD used by a VPLMN.

Each SST and each SD which configure one S-NSSAI may have values or may not have values, according to situations.

Network slice selection assistance information (NSSAI) may consist of one or more NSSAIs. Examples of the NSSAI may include configured NSSAI stored in a UE, requested NSSAI requested by a UE, allowed NSSAI usable by a UE determined by an NF (e.g., an AMF, a NSSF, or the like) of a 5G core network, subscribed NSSAI to which the UE subscribes, or the like, but this is merely an example, and examples of the NSSAI are not limited to those described above.

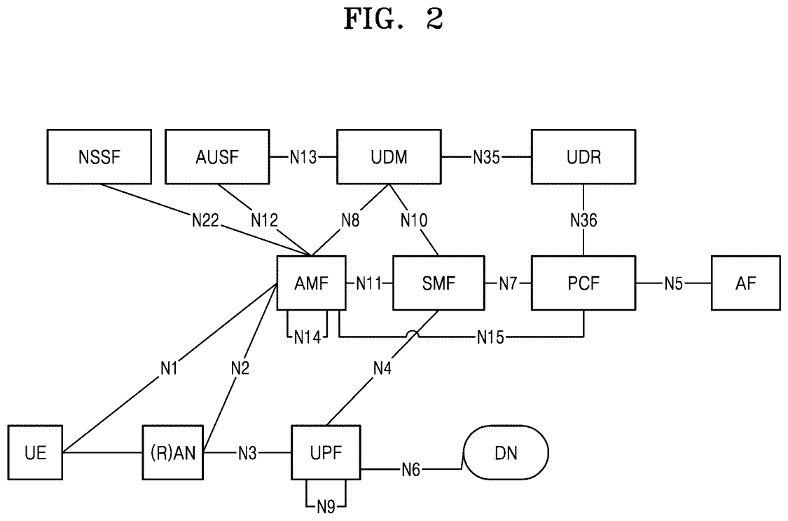

FIG. 2 illustrates architecture of a mobile communication system according to an embodiment of the disclosure.

Referring to FIG. 2, a 5G system (5GS) (N13, N35, N22, N12, N8, N10, N36, N14, N11, N7, N5, N14, N15, N1, N2, N4, N3, N9, and N6) may consist of a UE, a new radio (NR) base station (NG-RAN), and a 5G core network. Referring to FIG. 2, the 5G core network may consist of an access and mobility management function (AMF), a session management function (SMF), a user plane function (UPF), a policy control function (PCF), a unified data management (UDM), a network slice selection function (NSSF), an authentication server function (AUSF), a unified data repository (UDR), or the like. A user terminal may access the 5G core network via the BS ((R)AN). Hereinafter, the user terminal may be referred to as the UE, and the (R)AN may be referred to as a BS. In addition, the 5G core network may further include an application function (AF) and a data network (DN).

According to an embodiment of the disclosure, the AMF is an NF that manages wireless network access and mobility with respect to a UE.

The SMF is an NF managing a session with respect to a UE, and session information may include quality of service (QoS) information, charging information, packet processing information, or the like.

The UPF is an NF processing user plane traffic and is controlled by the SMF.

The PCF is an NF that manages an operator policy for providing a service in a wireless communication system. In addition, the PCF may be divided into a PCF that manages an access and mobility (AM) policy and a UE policy and a PCF that manages a session management (SM) policy. The PCF managing the AM/UE policies and the PCF managing the SM policy may be NFs that are logically or physically separate or may be one NF in a logical or physical manner.

The UDM is an NF that stores and manages UE subscription of a UE.

A UDR is an NF or a database (DB) which stores and manages data. The UDR may store UE subscription information and may provide the UE subscription information to the UDM. In addition, the UDR may store operator policy information and may provide the operator policy information to the PCF.

The NSSF may be an NF that selects network slice instances servicing a UE or performs a function of determining NSSAI.

The AUSF may be an NF that performs a function for supporting authentication for a 3GPP access and a non-3GPP access.

The AF may be an NF that provides a function for a service according to the disclosure.

The DN may be a data network capable of providing an operator service, an Internet access, a 3^{rd} party service, or the like.

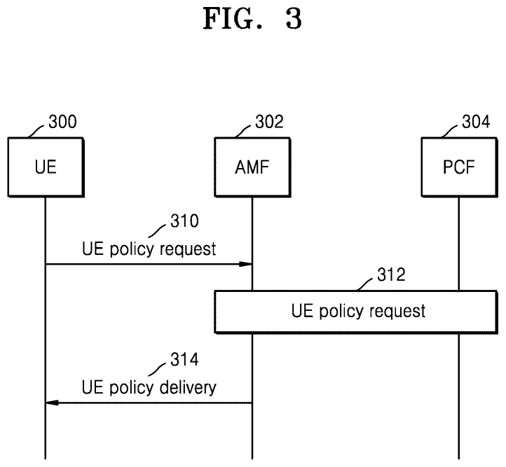

FIG. 3 illustrates a procedure in which an AMF transmits UE policy information to a UE in a wireless communication system according to an embodiment of the disclosure.

Referring to FIG. 3, in operation 310, a UE 300 may request an AMF 302 for UE policy information. The procedure of FIG. 3 may be performed during a UE registration procedure. Alternatively, the procedure of FIG. 3 may be performed as an independent procedure.

In operation 312, the AMF 302 may obtain UE policy information from a PCF 304. The PCF 304 may retrieve the UE policy information stored in a UDR.

In operation 314, the AMF 302 may transmit the UE policy information to the UE 300. When UE policy information transmission shown in FIG. 3 is performed during a UE registration procedure, a message in operation 314 may be a Registration Accept message.

Table 1 below is an example of the UE policy information received by the UE 300.

TABLE 1

| | |
|---|---|
| Traffic Descriptor: | Network Slice Selection: S-NSSAI-a |
| Application descriptor = App1 | |
| Traffic Descriptor: | Network Slice Selection: S-NSSAI-a |
| Application descriptor = App2 | |
| Traffic Descriptor: | Network Slice Selection: S-NSSAI-b |
| Application descriptor = App3 | |
| Traffic Descriptor: | Network Slice Selection: S-NSSAI-c |
| Application descriptor = App4 | |

The UE 300 may establish a Protocol Data Unit (PDU) session, based on the received UE policy information. For example, the UE 300 may establish a PDU session corresponding to S-NSSAI-a for transmission and reception of data of App1. The UE 300 may re-use the pre-established PDU session corresponding to S-NSSAI-a for transmission and reception of data of App2. The UE 300 may establish a PDU session corresponding to S-NSSAI-b for transmission and reception of data of App3. The UE 300 may establish a PDU session corresponding to S-NSSAI-c for transmission and reception of data of App4. For example, when two or more applications (e.g., App1 and App2) are associated with the same network slice (S-NSSAI-a), the UE 300 may transmit and receive data of the two or more applications on one PDU session mapped to the network slice.

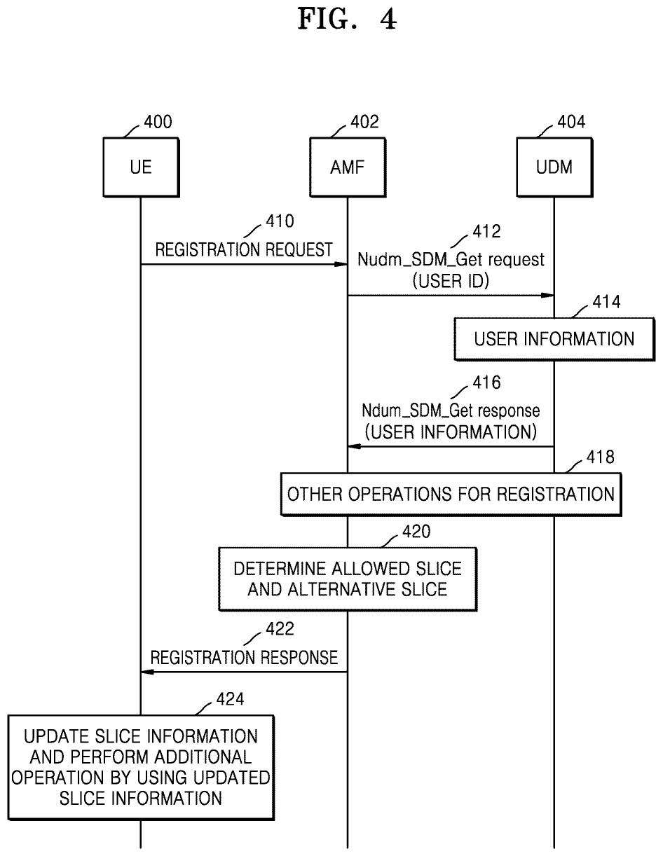

FIG. 4 illustrates a procedure of determining and managing alternative slice information in a registration procedure in a wireless communication system according to an embodiment of the disclosure.

Referring to FIG. 4, in operation 410, a UE 400 may perform a registration procedure.

In operation 410, the UE 400 may transmit a registration request message to an AMF 402. The registration request message may include requested NSSAI the UE 400 attempts to use. Based on that the UE 400 supports a network slice replacement function, the registration request message may include information indicating that the UE 400 supports the network slice replacement function.

In operation 412, the AMF 402 processes a registration request with respect to the UE 400, and transmits, to a UDM 404, a request message for receiving subscription information from the UDM 404. The request message may be a Nudm_SDM_Get request message, and may include an identifier (ID) of the UE (subscriber) 400.

In operation 414, the UDM 404 generates a response including subscription information of the UE (subscriber) 400, according to a request from the AMF 402. A response message including UE subscription information may include subscribed S-NSSAI information of the UE 400.

In operation 416, the UDM 404 transmits the subscription information of the UE (subscriber) 400 to the AMF 402, and a message used herein may be a Nudm_SDM_Get response message.

In operation 418, other operations for registration may be performed.

In operation 420, the AMF 402 may determine an allowed slice and an alternative slice. The AMF 402 may determine Allowed NSSAI, based on requested NSSAI received in operation 410 and subscribed S-NSSAIs received in operation 416.

In operation 420, the AMF 402 may determine whether at least one S-NSSAI (first S-NSSAI) included in the allowed NSSAI is unavailable or congested. The AMF 402 may determine whether the first S-NSSAI included in the allowed NSSAI is unavailable or congested, based on at least one of information received from other NF (e.g., a PCF, a NSSF, a NWDAF, or the like), information received from an OAM, or local configuration information stored in the AMF 402.

In operation 420, the AMF 402 may determine alternative S-NSSAI (second S-NSSAI) to replace the unavailable first-NSSAI, based on the information indicating whether the UE 400 supports network slice replacement, the information received from the UE 400 in operation 410, and an operator policy (a local policy). For example, the AMF 402 may determine alternative S-NSSAI only for S-NSSAI for which the UE 400 established a PDU session. Alternatively, the AMF 402 may determine alternative S-NSSAI, regardless of PDU session establishment of the UE 400, i.e., even for S-NSSAI for which the UE 400 did not establish a PDU session. When the AMF 402 determines to determine the alternative S-NSSAI (the second S-NSSAI) to replace the unavailable first S-NSSAI, the AMF 402 may determine information about the alternative S-NSSAI, i.e., the second S-NSSAI, to replace the unavailable first S-NSSAI, based on at least one of the information received from other NF (e.g., the PCF, the NSSF, the NWDAF, or the like), the information received from the OAM, or the local configuration information stored in the AMF 402. Here, the first S-NSSAI may be subscribed S-NSSAI of the UE 400. The subscribed S-NSSAI may be stored in the UDM 404, and may be one of S-NSSAIs included in the message the AMF 402 received in operation 416. In addition, the second S-NSSAI may be or may not be subscribed S-NSSAI of the UE 400. The AMF 402 may configure alternative slice mapping information (information of mapping between the first S-NSSAI and the second S-NSSAI), i.e., alternative NSSAI. Table 2 below shows an example of the alternative NSSAI. The alternative NSSAI may include one or more Entries.

TABLE 2
<Alternative NSSAI information element>

| | | | | | | | |
|---|---|---|---|---|---|---|---|
| 8 | 7 | 6 | 5 | 4 | 3 | 2 | 1 |

| | |
|---|---|
| Alternative NSSAI IEI | octet 1 |
| Length of Alternative NSSAI contents | octet 2 |
| Entry 1 | octet 3* |
| | octet a* |
| Entry 2 | octet a + 1* |
| | octet b* |
| . . . | octet b + 1* |
| | octet c* |
| Entry n | octet c + 1* |
| | octet d* |

Table 3 below shows an example of an Entry. The Entry may include information of one S-NSSAI (first S-NSSAI) and alternative S-NSSAI (second S-NSSAI) to replace the S-NSSAI.

TABLE 3
<Entry>

| | | | | | | | |
|---|---|---|---|---|---|---|---|
| 8 | 7 | 6 | 5 | 4 | 3 | 2 | 1 |

| | |
|---|---|
| S-NSSAI to be replaced | octet 3 |
| | octet x |
| Alternative S-NSSAI | octet x + 1 |
| | octet a |

The AMF 402 may include alternative S-NSSAI (second S-NSSAI) in Allowed NSSAI so as to use the alternative S-NSSAI (the second S-NSSAI). For example, the Allowed NSSAI may include both the first S-NSSAI and the second S-NSSAI.

The AMF 402 may determine whether the second S-NSSAI is included in configured NSSAI of the UE 400. Based on that the second S-NSSAI is not included in current configured NSSAI (first configured NSSAI) of the UE 400, the AMF 402 may include at least one of the second S-NSSAI and the alternative NSSAI (the information of mapping between the first S-NSSAI and the second S-NSSAI) in configured NSSAI (second configured NSSAI).

The AMF 402 may configure a registration response message including the allowed NSSAI determined in operation 420. In addition, the registration response message may include the second configured NSSAI. The registration response message may include the alternative NSSAI (the information of mapping between the first S-NSSAI and the second S-NSSAI).

The AMF 402 may store alternative network slice information. The alternative network slice information is as below:
at least one of an indicator indicating whether alternative S-NSSAI is used, Allowed NSSAI, first S-NSSAI (S-NSSAI to be replaced), second S-NSSAI (alternative S-NSSAI for the S-NSSAI), or information of mapping between the first S-NSSAI and the second S-NSSAI (Alternative NSSAI)
when there is a PDU session established for the first S-NSSAI or the second S-NSSAI, information (e.g., PDU session ID, or the like) about the PDU session established for the first S-NSSAI or the second S-NSSAI

The AMF 402 may store the alternative network slice information in UE context associated with the UE 400.

In operation 422, the AMF 402 may transmit a registration response message to the UE 400, and the message may include at least one of the allowed NSSAI, the configured NSSAI, or the alternative NSSAI (alternative slice mapping information), which are determined by the AMF 402 in operation 420.

In operation 424, the UE 400 may store the slice information received from the AMF 402, and may perform an additional operation.

In order to describe embodiments below of the disclosure, the Allowed NSSAI and the Alternative NSSAI which are determined by the AMF 402 in the procedure of FIG. 4 are as shown in Table 4 below, and embodiments below will now be described. First S-NSSAI, second S-NSSAI, and third S-NSSAI may be configured in the form of an IE shown in FIG. 1.

TABLE 4
Allowed NSSAI: First S-NSSAI, Second S-NSSAI, Third S-NSSAI
Alternative NSSAI: (First S-NSSAI, Third S-NSSAI), (Second
S-NSSAI, Third S-NSSAI)

The AMF 402 may determine to include the first S-NSSAI and the second S-NSSAI in the Allowed NSSAI, based on the request NSSAI and the subscribed S-NSSAIs. In addition, the AMF 402 may determine that the first S-NSSAI is currently unavailable/congested, and may determine the third S-NSSAI as alternative S-NSSAI to replace the first S-NSSAI. In addition, the AMF 402 may determine that the second S-NSSAI is currently unavailable/congested, and may determine the third S-NSSAI as alternative S-NSSAI to replace the second S-NSSAI. Accordingly, the AMF 402 may include the third S-NSSAI in Allowed NSSAI. The AMF 402 may configure the Allowed NSSAI.

The allowed NSSAI may include information of mapping between the first S-NSSAI that is to be replaced for being unavailable/congested and the third S-NSSAI that is alternative S-NSSAI. In addition, the allowed NSSAI may include information of mapping between the second S-NSSAI that is to be replaced for being unavailable/congested and the third S-NSSAI that is alternative S-NSSAI.

The AMF 402 may store the Allowed NSSAI and the alternative NSSAI as UE context. The AMF 402 may transmit a registration response message including the allowed NSSAI and the alternative NSSAI to the UE 400. The UE 400 may store the received Allowed NSSAI and the received alternative NSSAI, and may perform a next operation by using the stored information.

In order to describe embodiments below of the disclosure, a UE route selection policy (URSP) received by a UE in the procedure of FIG. 3 is as shown in Table 5 below, and embodiments below will now be described. According to the UE policy information (URSP), application 1 (App1) of a UE may use first S-NSSAI, and application 2 (App2) may use second S-NSSAI.

TABLE 5

| | |
|---|---|
| Traffic Descriptor: | Network Slice Selection: First S-NSSAI |
| Application descriptor = App1 | |
| Traffic Descriptor: | Network Slice Selection: Second S-NSSAI |
| Application descriptor = App2 | |

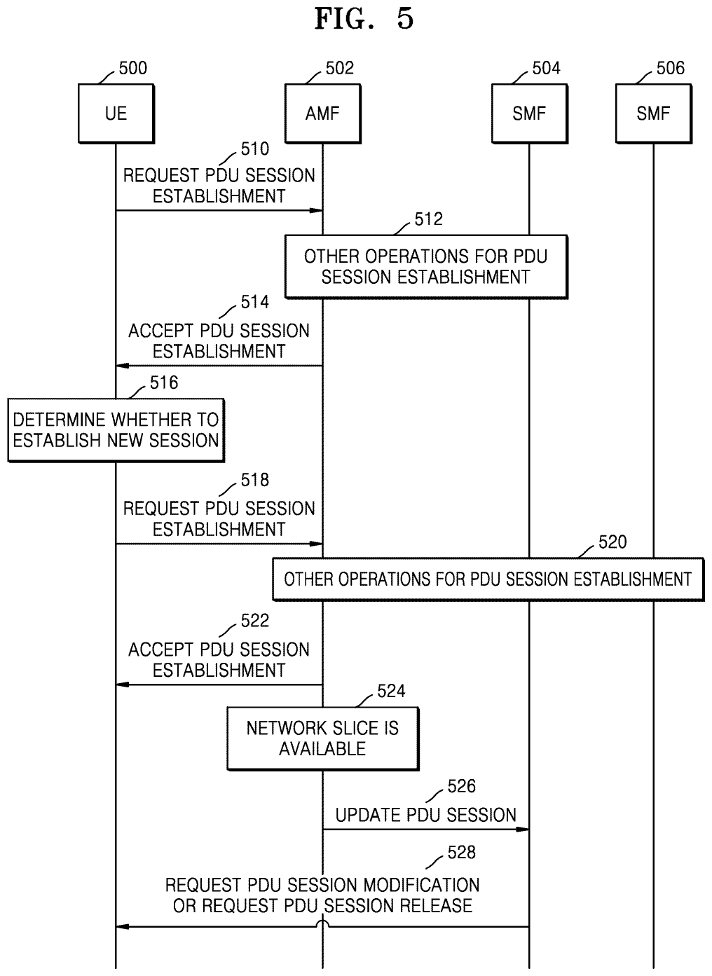

FIG. 5 illustrates a new PDU session establishment procedure in a wireless communication system according to an embodiment of the disclosure.

Referring to FIG. 5, in operation 510, a UE 500 may determine to establish a PDU session to use App1, based on at least one of allowed NSSAI, Alternative NSSAI, or a URSP. The UE 500 may determine that a network slice to use App1 is first S-NSSAI, based on the URSP. The UE 500 may determine that the first S-NSSAI is an available network slice, based on the allowed NSSAI. The UE 500 may determine that third S-NSSAI is used as alternative S-NSSAI, as replacement of the first S-NSSAI, based on the alternative NSSAI. The UE 500 may configure a PDU session establishment request message for using App1. The PDU session establishment request message may include at least one of PDU session ID, first S-NSSAI or third S-NSSAI. The UE 500 may transmit the PDU session establishment request message to an AMF 502.

In operation 512, the AMF 502 may process a PDU session establishment request of the UE 500. The AMF 502 may perform a PDU session establishment procedure with an SMF 504 that supports first S-NSSAI and/or third S-NSSAI requested by the UE 500.

In operation 514, the AMF 502 may transmit a PDU session establishment accept message to the UE 500. The PDU session establishment accept message may include PDU session ID and at least one of first S-NSSAI or third S-NSSAI.

The UE 500 may store established-PDU session information. For example, the UE 500 may store, as the PDU session information, first PDU session ID and at least one of first S-NSSAI or third S-NSSAI. The first S-NSSAI may be information transmitted from the UE 500 in operation 510. Alternatively, the first S-NSSAI may be information received by the UE 500 in operation 514. When S-NSSAI information is not provided in operation 510, the UE 500 may determine first S-NSSAI, based on alternative NSSAI, and third S-NSSAI information received in operation 514. The third S-NSSAI may be information received by the UE 500 in operation 514. Alternatively, the third S-NSSAI may be information received by the UE 500 in operation 510. The UE 500 may transmit and receive user data of App1 by using a first PDU session.

In operation 516, the UE 500 may determine whether to establish a new PDU session or re-use an existing PDU session so as to use App2, based on at least one of the allowed NSSAI, the alternative NSSAI, the URSP, or the PDU session information. The UE 500 may determine that a network slice for using App2 is second S-NSSAI, based on the URSP. The UE 500 may determine that second S-NSSAI is an available network slice, based on the allowed NSSAI. The UE 500 may determine that third S-NSSAI is used as alternative S-NSSAI, as replacement of second S-NSSAI, based on the Alternative NSSAI. The UE 500 may identify that a PDU session indicated by the first PDU session ID, from among existing sessions currently established by the UE 500, corresponds to first S-NSSAI (S-NSSAI to be replaced) and/or third S-NSSAI (alternative S-NSSAI), based on the PDU session information. As the first S-NSSAI that corresponds to the PDU session indicated by the first PDU session ID is different from the second S-NSSAI that is a network slice for using App2, the UE 500 may determine not to re-use the existing PDU session but to establish a new PDU session. For example, although alternative S-NSSAI of the PDU session indicated by the first PDU session ID corresponds to alternative S-NSSAI for App2, the UE 500 may determine not to use the existing PDU session but to establish a new PDU session.

In operation 518, the UE 500 may configure a PDU session establishment request message for using App2. The PDU session establishment request message may include PDU session ID and at least one of second S-NSSAI or third S-NSSAI. The UE 500 may transmit the PDU session establishment request message to the AMF 502.

In operation 520, the AMF 502 may process a PDU session establishment request of the UE 500. The AMF 502 may perform a PDU session establishment procedure with an SMF 506 that supports second S-NSSAI and/or third S-NSSAI requested by the UE 500.

In operation 522, the AMF 502 may transmit a PDU session establishment accept message to the UE 500. The PDU session establishment accept message may include PDU session ID and at least one of second S-NSSAI or third S-NSSAI.

The UE 500 may store established-PDU session information. For example, the UE 500 may store second PDU session ID and at least one of second S-NSSAI or third S-NSSAI, as the PDU session information. The second S-NSSAI may be information transmitted from the UE 500 in operation 518. Alternatively, the second S-NSSAI may be information received by the UE 500 in operation 522. When S-NSSAI information is not provided in in operation 518, the UE 500 may determine second S-NSSAI, based on the Alternative NSSAI, and third S-NSSAI information received in operation 522. The third S-NSSAI may be information received by the UE 500 in operation 522. Alternatively, the third S-NSSAI may be information transmitted from the UE 500 in operation 518. The UE 500 may transmit and receive user data of App2 by using a second PDU session.

According to an embodiment of the disclosure, when one alternative S-NSSAI replaces different S-NSSAIs, a plurality of PDU sessions corresponding to the same alternative S-NSSAI may be established.

In operation 524, the AMF 502 may detect that first S-NSSAI that was unavailable/congested is available again/less congested. Accordingly, the AMF 502 may determine to use the first S-NSSAI again, and may determine not to use the third S-NSSAI, which was used as replacement of the first S-NSSAI, as alternative S-NSSAI of the first S-NSSAI. The AMF 502 may determine whether there is a PDU session established for the first S-NSSAI and the third S-NSSAI that is alternative S-NSSAI mapped thereto. For example, the AMF 502 may determine existence or non-existence of a PDU session corresponding to the condition, based on PDU session information (SM context) stored in the AMF 502. The AMF 502 may determine to transfer/change the first PDU session established for the first S-NSSAI and/or the third S-NSSAI to the first S-NSSAI.

In operation 526, the AMF 502 may transmit a PDU session update message to the SMF 504 that manages the first PDU session. The PDU session update message may include SM context ID and at least one of the first S-NSSAI or the third S-NSSAI. The SMF 504 may determine to change the first PDU session associated with the third S-NSSAI to the first S-NSSAI.

In operation 528, the SMF 504 may transmit a PDU session modification request message or a PDU session release request message to the UE 500. The PDU session modification request message or the PDU session release request message may change the first S-NSSAI.

The UE 500 may change network slice information included in SM context related to the firs PDU session, to the first S-NSSAI. For example, information of the alternative S-NSSAI (the third S-NSSAI) in network slice information (at least one of the first S-NSSAI or the third S-NSSAI) included in information related to the first PDU session established in operations 510 to 514 may be deleted.

The UE 500 may transmit and receive user data of App1 by still using the first PDU session. In addition, the UE 500 may transmit and receive user data of App2 by still using the second PDU session, regardless of modification of the first PDU session.

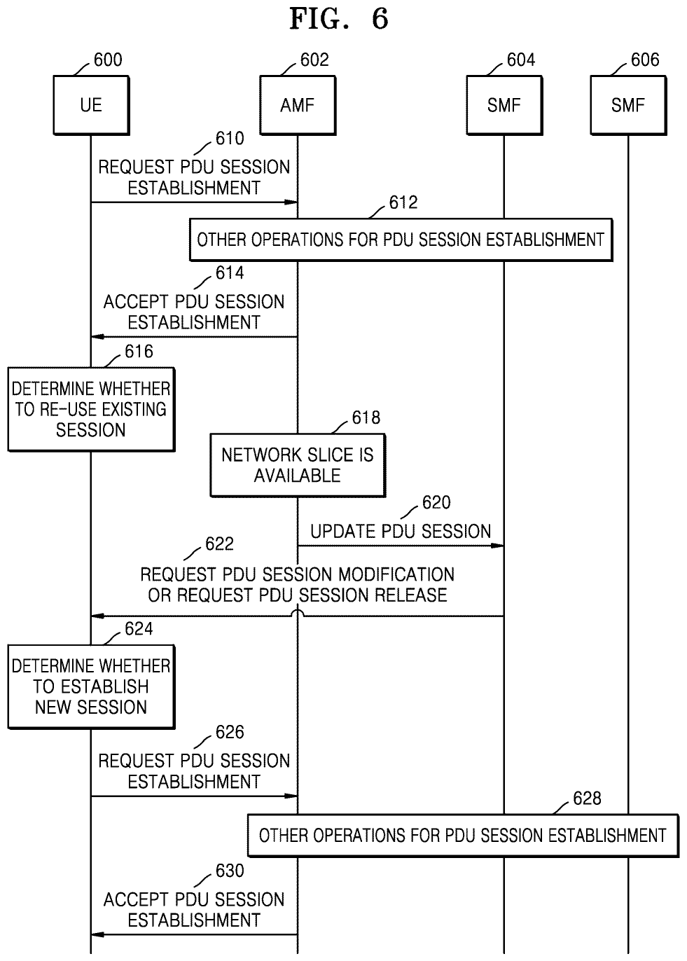

FIG. 6 illustrates a procedure for using an existing PDU session in a wireless communication system according to an embodiment of the disclosure.

Referring to FIG. 6, in operation 610, a UE 600 may determine to establish a PDU session for using App1, based on at least one of allowed NSSAI, alternative NSSAI, or a URSP. The UE 600 may determine that a network slice for using App1 is first S-NSSAI, based on the URSP. The UE 600 may determine that the first S-NSSAI is an available network slice, based on the Allowed NSSAI. The UE 600 may determine that third S-NSSAI is used as alternative S-NSSAI, as replacement of the first S-NSSAI, based on the Alternative NSSAI. The UE 600 may configure a PDU session establishment request message for using App1. The PDU session establishment request message may include PDU session ID and at least one of first S-NSSAI and third S-NSSAI. The UE 600 may transmit the PDU session establishment request message to an AMF 602.

In operation 612, the AMF 602 may process a PDU session establishment request of the UE 600. The AMF 602 may perform a PDU session establishment procedure with an SMF 604 that supports the first S-NSSAI and/or the third S-NSSAI requested by the UE 600.

In operation 614, the AMF 602 may transmit a PDU session establishment accept message to the UE 600. The PDU session establishment accept message may include PDU session ID and at least one of the first S-NSSAI or the third S-NSSAI.

The UE 600 may store established-PDU session information. For example, the UE 600 may store first PDU session ID and at least one of the first S-NSSAI or the third S-NSSAI, as the PDU session information. The first S-NSSAI may be information transmitted from the UE 600 in operation 610. Alternatively, the first S-NSSAI may be information received by the UE 600 in operation 614. When S-NSSAI information is not provided in operation 610, the UE 600 may determine first S-NSSAI, based on the Alternative NSSAI, and third S-NSSAI information received in operation 614. The third S-NSSAI may be information received by the UE 600 in operation 614. Alternatively, the third S-NSSAI may be information transmitted from the UE 600 in operation 610. The UE 600 may transmit and receive user data of App1 by using a first PDU session.

In operation 616, the UE 600 may determine whether to establish a new PDU session or re-use an existing PDU session so as to use App2, based on at least one of the allowed NSSAI, the Alternative NSSAI, the URSP, or the PDU session information. The UE 600 may determine that a network slice for using App2 is second S-NSSAI, based on the URSP. The UE 600 may determine that second S-NSSAI is an available network slice, based on the Allowed NSSAI. The UE 600 may determine that third S-NSSAI is used as alternative S-NSSAI, as replacement of second S-NSSAI, based on the alternative NSSAI. The UE 600 may identify that a PDU session indicated by the first PDU session ID, from among existing sessions currently established by the UE 600, corresponds to first S-NSSAI (S-NSSAI to be replaced) and/or third S-NSSAI (alternative S-NSSAI), based on the PDU session information. As alternative S-NSSAI of the PDU session indicated by the first PDU session ID corresponds to alternative S-NSSAI for App2, the UE 600 may determine to use an existing PDU session to transmit and receive user data of App2 by using the existing PDU session. For example, although the PDU session indicated by the first PDU session ID is different from second S-NSSAI that is a network slice for using App2, the UE 600 may determine not to establish a new PDU session but to re-use the established existing PDU session by using the same alternative S-NSSAI (third S-NSSAI). The UE 600 may transmit and receive user data of App2 by using the first PDU session.

According to an embodiment of the disclosure, when one alternative S-NSSAI replaces different S-NSSAIs, one PDU session corresponding to the same alternative S-NSSAI may be associated with different S-NSSAIs, and thus, may be used for transmission and reception of data.

In operation 618, the AMF 602 may detect that first S-NSSAI that was unavailable/congested is now available/less congested. Accordingly, the AMF 602 may determine to use the first S-NSSAI again, and may determine not to use the third S-NSSAI, which was used as replacement of the first S-NSSAI, as alternative S-NSSAI of the first S-NSSAI. The AMF 602 may determine whether there is a PDU session established for the first S-NSSAI and the third S-NSSAI that is alternative S-NSSAI mapped thereto. For example, the AMF 602 may determine existence or non-existence of a PDU session corresponding to the condition, based on PDU session information (SM context) stored in the AMF 602. The AMF 602 may determine to transfer/change the first PDU session established for the first S-NSSAI and/or the third S-NSSAI to the first S-NSSAI.

In operation 620, the AMF 602 may transmit a PDU session update message to the SMF 604 that manages the first PDU session. The PDU session update message may include SM context ID and at least one of first S-NSSAI or third S-NSSAI. The SMF 604 may determine to change the first PDU session associated with the third S-NSSAI to the first S-NSSAI.

In operation 622, the SMF 604 may transmit a PDU session modification request message or a PDU session release request message to the UE 600. The PDU session modification request message or the PDU session release request message may change the first S-NSSAI.

The UE 600 may change network slice information included in SM context related to the firs PDU session, to the first S-NSSAI. For example, information of the alternative S-NSSAI (the third S-NSSAI) in network slice information (at least one of the first S-NSSAI or the third S-NSSAI) included in information related to the first PDU session established in operations 610 to 614 may be deleted.

The UE 600 may transmit and receive user data of App1 by still using the first PDU session.

In operation 624, the UE 600 may not be able to transmit and receive user data of App2 by using the first PDU session, due to modification of the first PDU session. Accordingly, the UE 600 may determine to establish a new PDU session for using App2.

In operation 626, the UE 600 may configure a PDU session establishment request message for using App2. The PDU session establishment request message may include PDU session ID and at least one of second S-NSSAI or third S-NSSAI. The UE 600 may transmit the PDU session establishment request message to the AMF 602.

In operation 628, the AMF 602 may process a PDU session establishment request of the UE 600. The AMF 602 may perform a PDU session establishment procedure with an SMF 606 that supports the second S-NSSAI and/or the third S-NSSAI requested by the UE 600.

In operation 630, the AMF 602 may transmit a PDU session establishment accept message to the UE 600. The PDU session establishment accept message may include PDU session ID and at least one of the second S-NSSAI or the third S-NSSAI.

The UE 600 may store established-PDU session information. For example, the UE 600 may store second PDU session ID and at least one of the second S-NSSAI or the third S-NSSAI, as the PDU session information. The second S-NSSAI may be information transmitted from the UE 600 in operation 626. Alternatively, the second S-NSSAI may be information received by the UE 600 in operation 630. In operation 626, when S-NSSAI information is not provided, the UE 600 may determine the first S-NSSAI, based on the alternative NSSAI, and third S-NSSAI information received in operation 630. The third S-NSSAI may be information received by the UE 600 in operation 630. Alternatively, the third S-NSSAI may be information transmitted from the UE 600 in operation 626. The UE 600 may transmit and receive user data of App2 by using the second PDU session.

According to an embodiment of the disclosure, allowed NSSAI and alternative NSSAI which are determined by an AMF according to a mobile communication operator policy may be as shown in Table 6 below. For example, different network slices (first S-NSSAI and second S-NSSAI) may be replaced with different alternative S-NSSAIs (third S-NSSAI and fourth S-NSSAI). Accordingly, the UE 600 may establish different PDU sessions for respective slices (first S-NSSAI and second S-NSSAI), in a similar manner to the procedure shown in FIG. 5.

TABLE 6
Allowed NSSAI: First S-NSSAI, Second S-NSSAI, Third S-NSSAI,
Fourth S-NSSAI
Alternative NSSAI: (First S-NSSAI, Third S-NSSAI), (Second
S-NSSAI, Fourth S-NSSAI)

A UE according to an embodiment of the disclosure may not include S-NSSAI information in the PDU session establishment request message of operation 510 or 610.

In operation 512 or 612, an AMF may perform other operations for PDU session establishment.

In order to perform a PDU session establishment procedure, the AMF may select available or not-congested S-NSSAI from among S-NSSAIs included in Allowed NSSAI. The AMF may transmit the selected S-NSSAI to an SMF so as to establish a PDU session.

Based on that all S-NSSAIs included in the allowed NSSAI are unavailable or congested, the AMF may not select S-NSSAI. Accordingly, the AMF may reject a PDU session establishment request. In this case, a message of operation 514 or 614 may be a PDU session establishment rejection message. In addition, the AMF may determine to re-configure the UE. The AMF may transmit Alternative NSSAI to the UE. The Alternative NSSAI may include mapping information related to first S-NSSAI and third S-NSSAI. The alternative NSSAI may be transmitted to the UE during a registration procedure or a UE configuration update procedure. The UE may perform again a PDU session establishment request, based on the received alternative NSSAI. More particularly, the UE may include first S-NSSAI and third S-NSSAI in a PDU session establishment request message and may transmit the PDU session establishment request message to the AMF. The AMF may process the PDU session establishment request according to the procedure described with reference to FIG. 5 or 6.

Alternatively, when all S-NSSAIs included in Allowed NSSAI are unavailable or congested, the AMF may select one S-NSSAI (first S-NSSAI) from among the S-NSSAIs included in the allowed NSSAI, and may determine alternative S-NSSAI (third S-NSSAI) to replace the selected S-NSSAI (the first S-NSSAI). The AMF may transmit the first S-NSSAI and the third S-NSSAI to the SMF so as to establish a PDU session. The message of operation 514 or 614 may include the third S-NSSAI. In addition, the AMF may determine to re-configure the UE. The AMF may transmit Alternative NSSAI to the UE. The alternative NSSAI may include mapping information related to the first S-NSSAI and the third S-NSSAI. The alternative NSSAI may be transmitted to the UE during a registration procedure or a UE configuration update procedure. Based on the alternative NSSAI and the third S-NSSAI included in the PDU session establishment accept message, the UE may determine that the AMF selected the first S-NSSAI for PDU session establishment, and the third S-NSSAI is selected as alternative S-NSSAI because the first S-NSSAI is unavailable or congested.

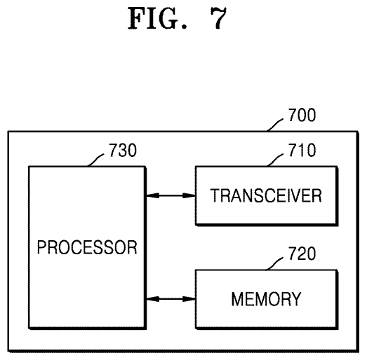

FIG. 7 is a diagram illustrating a configuration of a network entity according to an embodiment of the disclosure.

Referring to FIG. 7, a network entity 700 may be any one of an AMF, a SMF, a UPF, a PCF, a UDM, a NSSF, an AUSF, a UDR, an AF, and a DN. The network entity 700 of the disclosure may correspond to a network entity of FIGS. 2, 3, 4, 5, and 6 described above.

Referring to FIG. 7, the network entity 700 of the disclosure may include a transceiver 710, memory 720, and a processor 730. According to the operating method of the network entity 700, the processor 730, the transceiver 710, and the memory 720, which are of the network entity 700, may operate. However, elements of the network entity 700 are not limited to the example described above. The network entity 700 may include more elements than the aforementioned elements or may include fewer elements than the aforementioned elements. In addition, at least one of the processor 730, the transceiver 710, or the memory 720 may be implemented as one chip. The network entity 700 may include an NF, such as the AMF, the SMF, the UPF, the PCF, the UDM, the NSSF, the AUSF, the UDR, the AF, the DN, and the like. In addition, the network entity 700 may include a BS.

A receiver of the network entity 700 and a transmitter of the network entity 700 may be collectively referred to as the transceiver 710, and the transceiver 710 may transmit or receive a signal to or from a UE or other network entity. Here, the transmitted or received signal may include control information and data. To this end, the transceiver 710 may include a radio frequency (RF) transmitter for up-converting and amplifying a frequency of signals to be transmitted, and an RF receiver for low-noise-amplifying and down-converting a frequency of received signals. However, this is merely an example of the transceiver 710, and thus elements of the transceiver 710 are not limited to the RF transmitter and the RF receiver. The transceiver 710 may include a wired/wireless transceiver, and may include various configurations for transmitting and receiving signals.

In addition, the transceiver 710 may receive signals via communication channels (e.g., wireless channels) and output the signals to the processor 730, and may transmit signals output from the processor 730, via communication channels.

In addition, the transceiver 710 may receive and output a communication signal to the processor 730, and may transmit a signal output from the processor 730 to a UE or other network entity via wired/wireless networks.

The memory 720 may store programs and data necessary for operations of the network entity 700. In addition, the memory 720 may store control information or data which are included in a signal obtained by the network entity 700. The memory 720 may be implemented as a storage medium including read only memory (ROM), random access memory (RAM), a hard disk, a compact disc (CD)-ROM, a digital versatile disc (DVD), or the like, or any combination thereof.

The processor 730 may control a series of processes to allow the network entity 700, such as an SN to operate according to the aforementioned embodiments of the disclosure. The processor 730 may include at least one processor. The methods according to the embodiments of the disclosure as described herein or in the following claims may be implemented as hardware, software, or a combination of hardware and software.

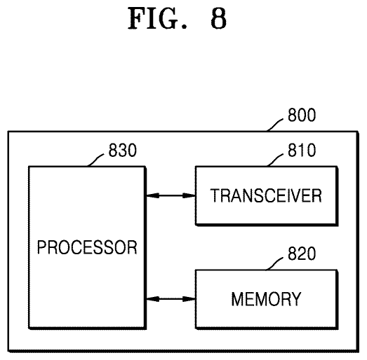

FIG. 8 is a diagram illustrating a configuration of a UE according to an embodiment of the disclosure. The UE of the disclosure may correspond to a UE of FIGS. 3, 4, 5, and 6 described above.

Referring to FIG. 8, a UE 800 of the disclosure may include a transceiver 810, memory 820, and a processor 830. According to the communication method of the UE 800, the processor 830, the transceiver 810, and the memory 820, which are of the UE 800, may operate. However, elements of the UE 800 are not limited to the example described above. The UE 800 may include more elements than the aforementioned elements or may include fewer elements than the aforementioned elements. In addition, the processor 830, the transceiver 810, and the memory 820 may be implemented as one chip.

A receiver of the UE 800 and a transmitter of the UE 800 may be collectively referred to as the transceiver 810, and the transceiver 810 may transmit or receive a signal to or from a BS or other network entity. The signal transmitted to or received from the BS or the network entity, by the UE 800, may include control information and data. To this end, the transceiver 810 may include a RF transmitter for up-converting and amplifying a frequency of signals to be transmitted, and an RF receiver for low-noise-amplifying and down-converting a frequency of received signals. However, this is merely an example of the transceiver 810, and thus elements of the transceiver 810 are not limited to the RF transmitter and the RF receiver.

In addition, the transceiver 810 may include a wired/wireless transceiver, and may include various configurations for transmitting and receiving signals.

In addition, the transceiver 810 may receive signals via wireless channels and output the signals to the processor 830, and may transmit signals output from the processor 830, via wireless channels.

In addition, the transceiver 810 may receive and output a communication signal to the processor 830, and may transmit a signal output from the processor 830 to a network entity via wired/wireless networks.

The memory 820 may store programs and data necessary for operations of the UE 800. In addition, the memory 820 may store control information or data which are included in a signal obtained by the UE 800. The memory 820 may be implemented as a storage medium including a ROM, a RAM, a hard disk, a CD-ROM, a DVD, or the like, or any combination thereof.

The processor 830 may control a series of processes to allow the UE 800 to operate according to the aforementioned embodiments of the disclosure. The processor 830 may include at least one processor. For example, the processor 830 may include a communication processor (CP) for performing control for communication, and an application processor (AP) for controlling a higher layer, such as an application program, or the like.

The methods according to the embodiments of the disclosure as described in claims or specification may be implemented as hardware, software, or a combination of hardware and software.

When implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including RAM or flash memory, ROM, electrically erasable programmable read only memory (EEPROM), a magnetic disc storage device, a CD-ROM, a DVD, another optical storage device, or a magnetic cassette. Alternatively, the programs may be stored in memory including a combination of some or all of the above-mentioned storage media. In addition, a plurality of such memories may be included.

In addition, the programs may be stored in an attachable storage device accessible via any or a combination of communication networks, such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the device performing the embodiments of the disclosure.

In the afore-described embodiments of the disclosure, elements included in the disclosure are expressed in a singular or plural form according to the embodiments of the disclosure. However, the singular or plural form is appropriately selected for convenience of descriptions and the disclosure is not limited thereto. As such, an element expressed in a plural form may also be configured as a single element, and an element expressed in a singular form may also be configured as plural elements.

In addition, the embodiments described above may be combined to be implemented, when required. For example, a BS, a UE, and a network entity may operate according to some combinations of the embodiments.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to an access and mobility management function (AMF), information indicating that the UE supports network slice replacement feature; and
in case that there is a protocol data unit (PDU) session associated with a single network slice selection assistance information (S-NSSAI) that needs to be replaced, receiving, from the AMF, a mapping of the S-NSSAI to an alternative S-NSSAI,
wherein, in case that the S-NSSAI is replaced by the alternative S-NSSAI, the PDU session is associated with both of the S-NSSAI and the alternative S-NSSAI.

2. The method of claim 1, further comprising, for an application, identifying, based on the S-NSSAI and not on the alternative S-NSSAI, whether to establish a PDU session for the application or to use the existing PDU session associated with the S-NSSAI for the application.

3. The method of claim 2, wherein the identifying comprises:
identifying whether the S-NSSAI matches with a first S-NSSAI associated with the application; and
in case that the first S-NSSAI does not match with the S-NSSAI, identifying to establish a PDU session for the application.

4. The method of claim 1, wherein a registration response message or a UE configuration update message includes the mapping which is transmitted to the UE.

5. A user equipment (UE) in a wireless communication system, the UE comprising:
a transceiver; and
at least one processor configured to:
transmit, to an access and mobility management function (AMF), information indicating that the UE supports network slice replacement feature; and
in case that there is a protocol data unit (PDU) session associated with a single network slice selection assistance information (S-NSSAI) that needs to be replaced, receive, from the AMF, a mapping of the S-NSSAI to an alternative S-NSSAI,
wherein, in case that the S-NSSAI is replaced by the alternative S-NSSAI, the PDU session is associated with both of the S-NSSAI and the alternative S-NSSAI.

6. The UE of claim 5, wherein the at least one processor is further configured to:
for an application, identifying, based on the S-NSSAI and not on the alternative S-NSSAI, whether to establish a PDU session for the application or to use the existing PDU session associated with the S-NSSAI for the application.

7. The UE of claim 6, wherein the at least one processor is configured to:
identify whether the S-NSSAI matches with a first S-NSSAI associated with the application; and
in case that the first S-NSSAI does not match with the S-NSSAI, identify to establish a PDU session for the application.

8. The UE of claim 5, wherein a registration response message or a UE configuration update message includes the mapping which is transmitted to the UE.

9. A method performed by an access and mobility management function (AMF) in a wireless communication system, the method comprising:
receiving, from a user equipment (UE), information indicating that the UE supports network slice replacement feature;
in case that single network slice selection assistance information (S-NSSAI) becomes unavailable or congested, determining that the S-NSSAI is to be replaced with an alternative S-NSSAI; and
in case that there is a protocol data unit (PDU) session associated with the S-NSSAI that needs to be replaced, transmitting, to the UE, a mapping of the S-NSSAI to the alternative S-NSSAI, wherein the mapping of the S-NSSAI to the alternative S-NSSAI is stored in UE context in the AMF.

10. The method of claim 9, further comprising:
identifying whether there is an established PDU session associated with the alternative S-NSSAI for the S-NSSAI being available again or not congested anymore;
in case that there is the established PDU session associated with the alternative S-NSSAI for the S-NSSAI being available again or not congested anymore, identifying to cause the established PDU session to be transferred to the S-NSSAI; and
transmitting, to a session management function (SMF), a PDU session update message to transfer the PDU session to the S-NSSAI.

11. The method of claim 9, wherein the alternative S-NSSAI is determined based on at least one of information from a network slice selection function (NSSF), information from a policy control function (PCF), information from an operations, administration and maintenance (OAM), or local configuration.

12. The method of claim 9, wherein a registration response message or a UE configuration update message includes the mapping which is transmitted to the UE.

13. An access and mobility management function (AMF) in a wireless communication system, the AMF comprising:
a transceiver; and
at least one processor configured to:
receive, from a user equipment (UE), information indicating that the UE supports network slice replacement feature;
in case that single network slice selection assistance information (S-NSSAI) becomes unavailable or congested, determine that the S-NSSAI is to be replaced with an alternative S-NSSAI; and
in case that there is a protocol data unit (PDU) session associated with the S-NSSAI that needs to be replaced, transmit, to the UE, a mapping of the S-NSSAI to the alternative S-NSSAI, wherein the mapping of the S-NSSAI to the alternative S-NSSAI is stored in UE context in the AMF.

14. The AMF of claim 13, wherein the at least one processor is further configured to:
identify whether there is an established PDU session associated with the alternative S-NSSAI for the S-NSSAI being available again or not congested anymore;
in case that there is the established PDU session associated with the alternative S-NSSAI for the S-NSSAI being available again or not congested anymore, identify to cause the established PDU session to be transferred to the S-NSSAI; and
transmit, to a session management function (SMF), a PDU session update message to transfer the PDU session to the S-NSSAI.

15. The AMF of claim 13, wherein the alternative S-NSSAI is determined based on at least one of information from a network slice selection function (NSSF), information from a policy control function (PCF), information from an operations, administration and maintenance (OAM), or local configuration.
